(19) United States
(12) Patent Application Publication
(10) Pub. No.: US 2018/0021612 A1
(43) Pub. Date: Jan. 25, 2018

(54) STABILIZED SUSPENSION FOR PRODUCTION OF FIRE-SUPPRESSING HYDROGELS

(71) Applicant: FireRein Inc., Napanee (CA)

(72) Inventors: Robert W. McLean, Belleville (CA); Rui Resendes, Toronto (CA); Stephanie R. White, Manotick (CA)

(21) Appl. No.: 15/656,322

(22) Filed: Jul. 21, 2017

Related U.S. Application Data
(60) Provisional application No. 62/365,477, filed on Jul. 22, 2016.

(51) Int. Cl. A62D 1/00

(52) U.S. Cl. CPC A62D 1/0064

(57) ABSTRACT

The present application provides a stabilized suspension for production of fire-suppressing hydrogels. Specifically, the present application provides a composition comprising: (i) at least one thickening agent; (ii) at least one liquid medium; and, (iii) at least one particulate suspending agent, wherein the composition consists of >75%, by weight, consumer-grade components and wherein the composition is a concentrate that forms a fire-suppressing hydrogel when mixed with water or an aqueous solution. Also provided is a hydrogel prepared from this composition methods of using the hydrogel to extinguish, suppress and/or prevent fires, including both class A and class B fires.

### FIELD OF THE INVENTION

The present application pertains to the field of firefighting agents. More particularly, the present application relates to water-enhancing, fire-suppressing hydrogels, compositions for forming such hydrogels and methods of manufacture and uses thereof.

### INTRODUCTION

Fire and its constructs are often described by the ‘Fire Tetrahedron’, which defines heat, oxygen, fuel, and a resultant chain reaction as the four constructs required to produce fire. Removal of any one component of the Fire Tetrahedron will prevent fire from occurring. There are five classes of fire, which are defined in terms of the combustion materials that have, or can be, ignited: Class A fires are from common combustibles, such as wood, cloth, etc.; Class B fires are from flammable liquids and gases, such as gasoline, solvents, etc.; Class C are from live electrical equipment, such as computers, etc.; Class D are from combustible metals, such as magnesium, lithium, etc.; and, Class K are from cooking media, such as cooking oils and fats.

Typically water is a first line of defence against certain classes of fires (e.g., class A), used not only to extinguish fires, but also to prevent them from spreading; due, at least in part, to water's ability to absorb heat via its high heat capacity (4.186 J/g° C.) and heat of vaporization (40.68 kJ/mol). Consequently, water cools surfaces and physically displaces air surrounding a fire, to deprive it of oxygen.

There are disadvantages to using water to fight fire and/or prevent it from spreading to nearby structures. Often, most of the water directed at a structure does not coat and/or soak into the structure itself to provide further fire protection, but rather is lost to run off and wasted; what water does soak into a structure is usually minimal, providing limited protection as the absorbed water quickly evaporates. Further, water sprayed directly on a fire tends to evaporate at the fire's upper levels, resulting in significantly less water penetrating to the fire's base to extinguish it.

Consequently, significant manpower and local water resources can be expended to continuously reapply water on burning structures to extinguish flames, or on nearby structures to provide fire protection. Furthermore, water alone is not effective in extinguishing, suppressing or protecting from other types of fires, such as Class B, Class D and Class K.

To address the drawbacks and limitations associated with the use of water as a fire-fighting material, significant research has been performed to develop additives that enhance water's capability to extinguish fires. Some of these additives include water-swellable polymers, such as cross-linked acrylic or acrylamide polymers, that can absorb many times their weight in water, forming gel-like particles. Once dispersed in water, these water-logged particles can be sprayed directly onto a fire, reducing the amount of time and water necessary for fighting fires, as well as the amount of water run off (for example, see U.S. Pat. Nos. 7,189,337 and 4,978,460).

Other additives include acrylic acid copolymers cross-linked with polyether derivatives, which are used to impart thixotropic properties on water (for examples, see U.S. Pat. Nos. 7,163,642 and 7,476,346). Such thixotropic mixtures thin under shear forces, allowing them to be sprayed from hoses onto burning structures or land; once those shear forces are removed, the mixture thickens, allowing it to cling to, and coat, surfaces, extinguish flames, and prevent fire from spreading, or the structure from re-igniting.

Additives employed in current commercial products are not naturally sourced and are not readily biodegradable. A drawback associated with these polymeric additives is that they can persist in the environment following their use during firefights, and/or can bio-accumulate or cause ill effects on surrounding environment.

Research into non-toxic, biodegradable, renewable, and/or naturally-sourced materials has increased in an effort to replace halogen-based and other synthetic firefighting materials, and reduce their environmental impact.

International PCT Application No. PCT/CA2015/051235, which is incorporated herein by reference in its entirety, provides an alternative fire-fighting composition that is effective and non-toxic. In particular, the application provides a composition that comprises at least one thickening agent, at least one liquid medium; and, optionally, one or more suspending agents, wherein the composition consists of >75%, by weight, consumer-grade components and wherein the composition is a concentrate that forms a fire-suppressing, water-enhancing hydrogel when mixed with water or an aqueous solution.

The above information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present application is to provide a stabilized suspension for production of fire-suppressing hydrogels. In accordance with an aspect of the present application, there is provided a composition comprising: (i) at least one thickening agent; (ii) at least one liquid medium; and, (iii) at least one particulate suspending agent, wherein the composition consists of >75%, by weight, consumer-grade components and wherein the composition is a concentrate that forms a fire-suppressing hydrogel when mixed with water or an aqueous solution.

In accordance with one embodiment, there is provided a hydrogel prepared from the composition defined above, and a method using the hydrogel to extinguish, suppress and/or prevent fires.

### DETAILED DESCRIPTION

### Definitions

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or ingredient(s) as appropriate.

As used herein, the term “consumer-grade components” refers to food-grade, personal care-grade, and/or pharmaceutical-grade components. The term “food-grade” is used herein to refer to materials safe for use in food, such that ingestion does not, on the basis of the scientific evidence available, pose a safety risk to the health of the consumer. The term “personal care-grade” is used herein to refer to materials safe for use in topical application such that, topical application does not, on the basis of the scientific evidence available, pose a safety risk to the health of the consumer. The term “pharmaceutical-grade” is used herein to refer to materials safe for use in a pharmaceutical product administered by the appropriate route of administration, such that administration does not, on the basis of the scientific evidence available, pose a safety risk to the health of the consumer.

As used herein, the term “non-toxic” is intended to refer to materials that are non-poisonous, non-hazardous, and not composed of poisonous materials that could harm human health if exposure is limited to moderate quantities and not ingested. Non-toxic is intended to connote harmlessness to humans and animals in acceptable quantities if not ingested and even upon ingestion, does not cause immediate serious harmful effects to the person or animal ingesting the substance. The term non-toxic is not intended to be limited to those materials that are able to be swallowed or injected or otherwise taken in by animals, plants, or other living organisms. The term non-toxic may mean the substance is classified as non-toxic by the Environmental Protection Agency (EPA), the World Health Organization (WHO), the Food and Drug Administration (FDA), Health Canada, or the like. The term non-toxic is therefore not meant to mean non-irritant or not causing irritation when exposed to skin over prolonged periods of time or otherwise ingested.

When used to describe the concentrated suspension or the resultant fire-suppressing hydrogel of the present application, the term non-toxic indicates that the composition is non-toxic to humans at concentrations and exposure levels required for effective use as fire-fighting, suppressing, and/or preventing agents, without the need for protective gear.

The term “room temperature” is used herein to refer to a temperature in the range of from about 20° C. to about 30° C.

The term “stabilized” as used herein in reference to the concentrate, or composition, of the present application, refers to the composition's ability to remain in suspension over time. In particular, a stabilized suspension is one (i) that does not exhibit visible separation, stratification or cyrstallization when stored for at least 30 days at room temperature, or (ii) that, when stored at room temperature in a standard 20 litre pail at a volume of 15-20 litres, will fully resuspend following four inversions of the pail within 1 minute.

The term “surface abrasion(s)” as used herein refers to any deviation from a surface's structural norm, such as, but not limited to, holes, fissures, gaps, gouges, cuts, scrapes, cracks, etc.

As used herein, the term “surface adhesion” refers to the ability of a composition to coat and/or adhere to a surface at any orientation (e.g., vertical cling). In referring to the hydrogel compositions of the present application, the term “surface adhesion” further refers to the ability of the hydrogel to adhere to a surface such that adequate fire fighting, suppression, and/or protection is afforded as a result of the surface being coated by the hydrogel.

As described above, International PCT Application No. PCT/CA2015/051235 discloses compositions for forming water-enhancing, fire-suppressing hydrogels having minimal toxicity and environmental impact. These compositions are considered to be water-enhancing and fire-suppressing since they can function to improve the fire suppressant affect of water. In particular, these compositions, or concentrates, comprise at least 75%, by weight, comsumer-grade components and are made from a combination of at least one liquid medium and at least one thickening agent, with additional optional additives. Mixture of the concentrate with water, or an aqueous solution, generates an effective fire-suppressing hydrogel.

It has now been observed that these concentrates can exhibit settling during storage. This can be a problem when the concentrate is used to form a fire-suppressing hydrogel, since additional mixing of the concentrate is required to resuspend the concentrate prior to its mixture with water, or an aqueous solution, to form the hydrogel. Consequently, this settling problem can cause a delay in use of the fire-suppressing hydrogel to extinguish, suppress and/or prevent a fire. Any such delay must be avoided in such situations to minimize a fire's threat to life, property and/or landscapes.

As described in PCT/CA2015/051235, the concentrate can include one or more suspending agents in order to minimize settling. It has now been found, however, that particulate, or heterogenous, suspending agents are particularly beneficial in stabilizing these concentrates. These particulate, or heterogeneous, suspending agents are insoluble or only sparingly soluble in the liquid medium of the concentrate. The use of suspending agents that are miscible with or soluble in the at least one liquid medium have been observed to be ineffective in fully resolving the settling issue. Accordingly, the present application provides a composition comprising: (i) at least one thickening agent; (ii) at least one liquid medium; and, (iii) at least one particulate suspending agent, wherein the composition consists of >75%, by weight, consumer-grade components and wherein the composition is a concentrate that forms a fire-suppressing hydrogel when mixed with water or an aqueous solution.

As detailed below, the presently disclosed hydrogel and the concentrate used to prepare the hydrogel, have been formulated to be non-toxic and environmentally benign. This has been achieved through the use of consumer-grade materials to prepare a water-enhancing fire-suppressant. Accordingly, the present compositions overcome many of the drawbacks associated with previous attempts at non-toxic, biodegradable, renewable, and/or naturally-sourced fire-suppressing agents.

Hydrogel-Forming Concentrates and their Components

The present application provides a concentrate composition, for use in producing hydrogels in situ, which comprises >75%, by weight, non-toxic, consumer-grade components. In certain embodiments, the components of the concentrate composition can also be biodegradable, renewable and/or naturally-sourced. Optionally, the concentrate composition comprises >80%, >85%, >90%, >95% or >98% non-toxic, consumer-grade components.

In certain examples, at least 75%, by weight, of the components of the concentrate are on the GRAS (Generally Recognized as Safe) list maintained by the U.S. Food and Drug Administration. Optionally, the concentrate composition comprises >80%, >85%, >90%, >95% or >98%, by weight, GRAS list components.

In certain embodiments the concentrate composition has a viscosity of >1000 cP, >2500 cP, >5000 cP, or >10 000 cP, for example, when measured using a Brookfield LVDVE viscometer with a CS-34 spindle at 6.0 rpm. In a particular example, the concentrate composition has a viscosity of approximately 7000 cP.

In one aspect the present application provides a liquid concentrate that is a suspension that comprises at least one thickening agent, a liquid medium, and at least one suspending agent, wherein the liquid concentrate will form a fire-suppressing hydrogel when mixed with water.

Thickening Agents

Hydrogel-forming concentrates, as herein described, require at least one species to act as a thickening agent to aid in generating a hydrogel. A thickening agent can be, for example, a polymer. Starch, which is a biodegradable, naturally-sourced polymer, can form gels in the presence of water and heat. Starch-based hydrogels can act as fire retardants due to their high water retaining and surface-adhesion capabilities [loanna G. Mandala (2012). Viscoelastic Properties of Starch and Non-Starch Thickeners in Simple Mixtures or Model Food, Viscoelasticity—From Theory to Biological Applications, Dr. Juan De Vicente (Ed.), ISBN: 978-953-51-0841-2, InTech, DOI: 10.5772/50221. Available from: http://www.intechopen.com/books/viscoelasticity-from-theory-to-biological-applications/viscoelastic-properties-of-starch-and-non-starch-thickeners-in-simple-mixtures-or-model-food]. One example of a natural starch-based, hydrogel-forming thickening agent is carboxymethylcellulose sodium salt, which has found use in personal lubricants, toothpastes, and ice creams as a thickener; it is food-grade and biodegradable, and can absorb water at concentrations as low as 1% in water. Other types of starch that are viable for use in the present concentrate include, but are not limited to, corn starch, potato starch, tapioca, and/or rice starch.

Other viable, naturally sourced, biodegradable thickening agents include natural gums, such as, but not limited to, guar gum, xanthan gum, sodium alginate, agar, and/or locust bean gum, some of which are used as thickeners in food, pharmaceutical and/or cosmetic industries. For example, guar gum is sourced primarily from ground endosperms of guar beans, and reportedly has a greater water-thickening potency than cornstarch; xanthan gum is produced by Xanthomonascamperstris [Tako, M. et al. Carbohydrate Research, 138 (1985) 207-213]. At low concentrations, xanthan gum or guar gum can confer an increase in viscosity to aqueous solutions; and, that imparted viscosity can change depending on what shear rates the solutions are exposed to, due to the gums' shear-thinning or pseudoplastic behaviour. Further, it has been observed that mixtures of xanthan and guar gum exhibit a synergistic effect: in addition to their shear-thinning properties, mixtures of xanthan and guar gum impart higher viscosities to aqueous solutions than each gum individually [Casas, J. A., et al. J Sci Food Agric 80:1722-1727, 2000].

In one embodiment of the present application, the concentrate comprises a combination of thickening agents, with an overall concentration of from about 30% to about 65%, by weight (based on the total weight of the concentrate), for example, from about 35% to about 60%, by weight, from about 40% to about 55%, by weight, or about 50%, by weight. In one example of this embodiment, the combination of thickening agents comprises a mixture of xantham gum, guar gum and corn starch.

Liquid Medium

As noted above, the hydrogel-forming concentrate is a liquid suspension. Suspending the components of the concentrate in a liquid medium facilitates its mixing with water, and potentially increases the rate and/or ease at which a hydrogel is formed for use to extinguish, suppress or protect against fire. Examples of non-toxic, consumer-grade liquid mediums include, but are not limited to, edible oils, such as nut/seed oils, or vegetable/plant oils, glycerol, and low molecular weight polyethylene glycol (PEG), with or without a small amount of water (for example, 5% or less, by weight, or from about 1% to about 3% by weight).

In addition to being naturally-sourced and/or food-grade, liquid mediums such as vegetable oil, glycerol, and PEG resist freezing at sub-zero temperatures; thus, concentrates formed with such liquid mediums can maintain their utility for forming hydrogels under winter and/or arctic conditions. Further, some liquid mediums, such as glycerol and PEG, are water-miscible, which can also enhance the ability of the concentrate to efficiently mix with water and form a hydrogel.

In certain embodiments, the concentrate comprises a mixture of more than one liquid media. In another embodiment, the liquid medium comprises canola oil. Optionally, the canola oil is used in combination with water.

The overall concentration of the liquid medium in the concentrate is in the range of from about 35% to about 55%, by weight, for example, from about 40% to about 50%, by weight, or from about 43% to about 47%, by weight, about 45%, by weight, or about 46%, by weight.

Suspending Agents

Hydrogel-forming liquid concentrates, formed from solid components (e.g., thickening agents) suspended or dissolved in a liquid medium (e.g., vegetable oil), typically exhibit settling of solid components over time. If such settling were to occur, the liquid concentrate can be physically agitated in order to re-suspend or re-dissolve its components. However, as noted above, this can be a problem when urgency is required in fighting or preventing fires. Accordingly, the concentrate composition of the present application comprises at least one particulate suspending agent (e.g., surfactant or emulsifier), or a combination of suspending agents in which at least one is a particulate suspending agent, to stabilize the composition, or to facilitate keeping solid components suspended or dissolved in the liquid medium, either indefinitely, or for a length of time sufficient to maintain the concentrate's utility for hydrogel formation. The concentrate of the present application is stable (i.e., does not exhibit settling, stratification or crystallization) when stored for at least 30 days at room temperature (i.e., between about 20° C. and about 30° C.). In certain examples, the concentrate exhibits stability when stored at temperatures in the range of from about 20° C. to about 45° C., or at temperatures in the range of about 0° C. to about 45° C., for at least 30 days.

The particulate suspending agent can be synthetic, naturally-occurring or organophilic, and is non-toxic, and, optionally, consumer-grade. Non-limiting examples of particulate suspending agents that can be incorporated into the present concentrate are silica, glycogen particles, clays (e.g., bentonite) and organophilically modified clays (e.g., organically modified montmorillonite). In the case of silica, the silica can be an amorphous silica, such as a fumed silica (for example, an Aerosil®), which can be a hydrophobic fumed silica.

The amount of particulate suspending agent included in the concentrate depends both on the nature of the liquid medium and the thickening agents in the concentrate and on the final viscosity required for the application of the concentrate. If the amount of the particulate suspending agent is too high the concentrate can display undesireable flow characteristics that impede its ability to efficiently form a hydrogel when combined with water.

In one embodiment, the concentrate comprises silica as the particulate suspending agent. In one example of this embodiment, the silica is present in the concentrate at a concentration of from about 0.1% to about 2%, by weight (based on the total weight of the concentrate), for example, from about 0.1% to about 1%, by weight, or from about 0.25% to about 0.75%, by weight, or about 0.5%, by weight.

In another embodiment, the concentrate comprises glycogen particles as the particulate suspending agent. In one example of this embodiment, the glycogen particles are glycogen nanoparticles, for example, phyto-glycogen nanoparticles. Such phyto-glycogen nanoparticles are commercially available, for example, from Mirexus Inc., and are entirely safe (edible), water-soluble and biodegradeable. In one example of this embodiment, the phyto-glycogen nanoparticles are present in the concentrate at a concentration of from about 0.1% to about 15%, or from about 0.3% to about 10%, or from about 0.4% to about 5%, or from about 1% to about 5%, by weight (calculated based on the overall weight of the concentrate).

Examples of non-toxic, consumer-grade, non-particulate surfactants and/or emulsifiers that can be used in combination with the particulate suspending agent(s) include, but are not limited to, lecithins (e.g., Metarin™), lysolecithins, polysorbates, sodium caseinates, monoglycerides, fatty acids, fatty alcohols, glycolipids, and/or proteins [Kralova, I., et al. Journal of Dispersion Science and Technology, 30:1363-1383, 2009]. Such surfactants can be provided as solids or liquids.

The addition of a suspending agent, such as a surfactant, or combination of surfactants, to the concentrate, can increase the viscosity of the concentrate and/or increase the viscosity of the hydrogel formed following dilution of the concentrate with water. This effect of the surfactant, or combination of surfactants, occurs as a result of their suspension action, and/or by increasing the amount of material that can be included in the concentrate or the resultant hydrogel.

In certain embodiments, the surfactant(s) used in the concentrate is a liquid. As would be readily appreciated by one skilled in the art, such liquid surfactants can be more easily mixed with the liquid medium of a liquid concentrate than can a solid surfactant. Accordingly, the liquid surfactant(s) may, in some examples, be more effective at maintaining the solid components in suspension and/or solution.

In a comparison study, it was found that the use of lecithin in the absence of a particulate suspending agent resulted in an unstable suspension. In particular, significant settling of the suspension was observed during storage at room temperature. The addition of the particulate suspending agent was required to address this settling problem.

In one embodiment, the concentrate of the present application comprises a particulate suspending agent and a non-particulate suspending agent. In one example of this embodiment, the concentrate comprises a combination of the particulate and the non-particulate suspending agent at a concentration of from about 0.2% to about 6% by weight, for example, from about 0.5% to about 5.5%, by weight, or from about 2% to about 5%, by weight, or from about 3.5% to about 5%, by weight.

In one embodiment, the concentrate comprises a combination of silica and a lecithin.

Additives

Other components, or additives, can be added to the concentrate in order to affect or alter one or more properties of the concentrate or the hydrogel formed from the concentrate. The appropriate additive(s) can be incorporated as required for a particular use. For example, additives can be added to affect the viscosity and/or stability of the concentrate, and/or the resultant hydrogel. Additional additives that can be incorporated in the present concentrate and hydrogel compositions include, but are not limited to, pH modifiers, dispersing agents (e.g., surfactants, emulsifiers, clays), salts, anti-microbial agents, antifungal agents and pigments or dyes/coloring agents. Specific, non-limiting examples of non-toxic, consumer-grade additives include: sodium and magnesium salts (e.g., borax, sodium bicarbonate, sodium sulphate, magnesium sulphate), which can affect hydrogel viscosity and/or stability [Kesavan, S. et al., Macromolecules, 1992, 25, 2026-2032; Rochefort, W. E., J. Rheol. 31, 337 (1987)]; chitosan or epsilon polylysine, which can act as anti-microbials [Polimeros: Ciencia e Tecnologia, vol. 19, no 3, p. 241-247, 2009; http://www.fda.gOv/ucm/groups/fdagov-public/@fdagov-foods-gen/documents/document/ucm 267372.pdf (accessed Sep. 26, 2014)], and pectin, which can aid in the formation of hydrogels.

As would be readily appreciated by a worker skilled in the art, the additive(s) can be added to the concentrate, or the additive(s) can be added during formation of the hydrogel, or the additive(s) can be added to the hydrogel.

The concentrate is prepared by mixing the components in any order, typically under ambient conditions. The relative amounts of each component, in particular the thickening agent, liquid agent, and, when present, the suspending agent, are selected based, at least in part, on the desired viscosity of the concentrate. Once formed, the concentrate has a shelf life of about 30 days, 1-3 months, 3-6 months, 6-9 months, 9-12 months, 12-15 months, 15-18 months, 18-21 months, 21-24 months, or >24 months.

Hydrogel Formation and Application

A water-enhancing, fire-suppressing hydrogel as herein described can be formed by mixing a concentrate, as described above, with water or an aqueous solution. The term “hydrogel” is used herein to refer to the gel-like material formed from the mixture of the concentrate with water, which can be an aqueous solution of some or all of the components of the concentrate and/or an aqueous dispersion of some or all of the components of the concentrate.

When applied using firefighting equipment, the concentrate is mixed with the equipment's water supply or mixed with water in a reservoir, and then applied to target objects (such as, structures, edifices and/or landscape elements) to extinguish, suppress or prevent fire or to protect the target objects from fire.

Firefighting equipment useful in applying the hydrogels of the present application, comprises a means for mixing the concentrate with water or an aqueous solution and means for spraying, or otherwise applying, the resultant hydrogel onto the target objects. In one embodiment, the firefighting equipment additionally comprises a reservoir for holding the concentrate until required; the reservoir is in fluid communication with the mixing means such that the concentrate can be moved from the reservoir to the mixing means for mixing with the water or aqueous solution. In another embodiment, the firefighting equipment additionally comprises means for introducing water or an aqueous solution to the means for mixing, or a reservoir fluidly connected to the means for mixing, such that the water or aqueous solution can be moved from the reservoir to the mixing means for mixing with the concentrate. Non-limiting examples of firefighting equipment include a fire extinguisher (e.g., an air over water extinguisher) spray nozzle-equipped backpacks, or sprinkler systems. The firefighting equipment can be mounted on or in a vehicle, such as, a truck, airplane or helicopter.

In accordance with one embodiment, in which the hydrogel is used for firefighting using fire trucks, or other firefighting vehicles, including aircrafts, the herein described hydrogels are formed and used via the following, non-limiting process: the hydro-gel forming concentrate is added to a truck's water-filled dump tank and/or other portable tank, and mixed with the water via a circulating hose, or equivalent thereof; pumping the hydrogel, once formed, out of the tank(s), and applying the hydrogel to the target objects (e.g., edifices or landscape elements), via a hard suction hose, or equipment equivalent thereof.

In an alternative embodiment, the concentrate is added directly to a vehicle's onboard water tank, either manually or via an injection system, and mixed via circulation in the tank. In one example of this embodiment, the injection system comprises an ‘after the pump’ system that injects specified amounts of concentrate into water that has passed through the vehicle's pump, and is about to enter the fire hose; friction of, or the shear forces caused by, the water moving through the hose assists in mixing the concentrate with the water to produce the hydrogel in the hose. In another specific example, the injection system pumps the concentrate from a dedicated reservoir to an injection pipe that introduces concentrate into the water just prior to the hose line; a computerized system calculates water flow via a flow meter on said injection pipe to inject required amounts of concentrate into the pipe and hose stream via a specially designed quill.

Fire-fighting vehicles suitably equipped with an in-line injection system, allow the concentrate to be added directly in-line with the water, which can then be mixed via physical agitation and/or shear forces within the hose itself.

As would be readily appreciated by a worker skilled in the art, although the methods for hydrogel formation described above specifically refer to a fire fighting truck, such methods are equally applicable to fire fighting using aircraft, such as airplanes or helicopters, where the hydrogel is formed and then air dropped from the aircraft.

In another embodiment, the hydrogel formulation is made from the concentrate at the time of fire fighting using fire fighting backpacks. In this embodiment the concentrate can be added to directly to the backpack's water-filled reservoir, and manually or mechanically shaken to form the hydrogel. Once formed, the hydrogel can be applied to requisite objects, or surfaces, via the backpacks' spray-nozzles.

In another embodiment, the concentrates as herein described can be added to a sprinkler system's water supply, such that, upon activation as a result heat, smoke, and/or fire detection, the system sprays the hydrogel, as described herein, rather than simply water (as in current practice). In one embodiment, once a sprinkler system is activated, a dedicated pump system injects concentrate into the sprinkler's water system, producing a hydrogel with properties compatible with the sprinkler's flow requirements, prior to being applied to an object or area (e.g., an edifice, room or landscape area). In another embodiment, the sprinkler system comprises sprinkler heads designed to provide an optimized spray pattern for applying a hydrogel to an object or area (e.g., an edifice, room or landscape area).

In yet another embodiment, a sprinkler system for applying the hydrogels as described herein comprises: a dedicated pump for injecting concentrate, as described herein, into the sprinkler's water system or for drawing the concentrate into the sprinkler system's water stream; a sprinkler head designed to provide an optimized spray pattern for hydrogel application; a computerized system to calculate water and/or hydrogel flow; a flow meter to detect water flow in dry pipes; and, a point of injection designed to introduce the concentrate into the water in such a way that is compatible with the sprinkler system and its intended use.

Hydrogel Firefighting Properties

The herein provided hydrogels, as formed from the concentrates also provided herein, are suitable for use as fire fighting agents due to their physical and/or chemical properties. The hydrogels are more viscous than water, and generally resist evaporation, run-off, and/or burning when exposed to high temperature conditions (e.g., fire), due to their water-absorbing, viscosity-increasing components. These hydrogels also exhibit shear-thinning, thixotropic, pseudoplastic, and/or non-Newtonian fluidic behaviour, such that their viscosity decreases when they are subjected to stresses, such as, but not limited to, shear stresses, wherein their viscosity increases again when those stresses are removed.

Consequently, once formed, the present hydrogels can be sprayed via hoses and/or spray-nozzles onto burning objects (e.g., edifices or landscape elements) in a manner similar to water; and, once the hydrogels are no longer subjected to the stresses of being sprayed, their viscosity will increase to be greater than that of water. As a result, the hydrogels coat and cling, at virtually any angle, to surfaces they are applied to, allowing them to extinguish fires by displacing oxygen and cooling surfaces, prevent fire flash-over, and/or further protect surfaces from re-ignition via the hydrogels' general resistance to evaporation, run-off, and/or burning.

Further, as the viscosity increase would not be instantaneous, the hydrogels can ‘creep’ or Ooze’ into surface abrasions or structural gaps, such as, but not limited to, cracks, holes, fissures, etc., in an edifice or landscape element, coating and protecting surfaces that would otherwise be difficult to protect with water, or other firefighting agents such as foams, due to evaporation or run-off. This will contribute an element of penetrative firefighting to a firefighter's arsenal: once the hydrogel's viscosity has increased, it will form a protective layer in, on, under and/or around said cracks, surface abrasions, structural gaps or the like. Also, use of the herein described hydrogels can minimize water damage to surfaces, since use of the hydrogels would replace the direct use of water in firefighting.

In one example, the hydrogel is applied at the head of an approaching fire, either as a fire break or to protect a property (e.g., cottage, house, or commercial or municipal building). Firefighters can proceed via “coat and approach” to protect Firefighters inside a circumference set by a coating of the hydrogel, allowing the Firefighters to create a protected route of egress.

To gain a better understanding of the invention described herein, the following examples are set forth. It should be understood that these examples are for illustrative purposes only. Therefore, they should not limit the scope of this invention in any way.

### EXAMPLES

### Example 1: Comparison with Commercial Gels and Foam in Knockdown of Class A Fires

A study was performed to compare fire suppression using the present hydrogel and commercially available products in terms of their:
water usage;
fire knockdown times; and
flame suppression and extinguishing effects.

Materials

The concentrate used to form the hydrogel had the following composition:

| Component | weight % |
|---|---|
| Canola oil | 44.9 |
| Xantham gum | 20.0 |
| Guar gum | 14.4 |
| Corn starch | 14.4 |
| Lecithin (Metarin ™ DA 51) | 4.0 |
| Silica (Aerosil ® R 974) | 0.2 |
| Water | 2.0 |

The concentrate was prepared by mixing 112 lb of canola oil with 50 lb of xantham gum for 5 minutes, adding 36 lb of guar gum and mixing for 10 minutes, adding 36 lb of corn starch and mixing for 10 minutes, adding 10 lb of lecithin and mixing for 10 minutes, adding 0.5 lb of silica and mixing for 10 minutes, and, finally, adding 5 lb of water and mixing for 15 minutes. All mixing was performed under ambient conditions. The resultant concentrate had a viscosity of approximately 6800 cPs at 25° C.

The prepared concentrate was divided between 8 pails and stored at room temperature until use.

The concentrate was mixed with water using an injection metering system, such that the amount of concentrate mixed with the water mixture could be adjusted. The mixing of the concentrate with the water stream occurred upstream at the engine pump.

The Competitor ‘A’ product in its primary form is a powder. When mixed with water, this product became a gel. To prevent gelling in the water tank, pump or hose, the powder was mixed with the water through a suction induction nozzle connected to the downstream outlet of a pressurized hose.

The Competitor ‘B’ product is a liquid concentrate that creates a foam when mixed with water. The liquid was mixed with the water upstream at the pump truck outlet through a suction inductor connection. The water hose used by the firefighters was then attached to this connection.

Methods

Test Arrangement:

Five identical test corner assemblies (TCAs) were fabricated. These assemblies replicated the corner of an interior room typically found in a residential home. Each assembly was comprised of 2×4 wood structural elements with side walls, a rear wall and ceiling sheathed with sheetrock panels. The floor joists were also of 2×4 construction with suitable plywood sheathing. Each test corner assembly incorporated 24 thermocouples (TC) temperature sensors. The thermocouple sensors protruded slightly through the drywall surfaces to measure the temperature of the conditions at the wall/room environment boundary.

The first test was the control in which a fire was started in the control test room assembly. Video equipment recorded the fire progression while temperature and time data was recorded. Water with gelling additive products was used to extinguish the fires.

Similar tests were conducted on the other 4 test corner assemblies. Each test corner assembly was dedicated to a specific gelling additive product. The set of trials on each test corner assemblies was broken down into specific tests to evaluate the specific gelling agent on the product manufacturer's recommended high ratio, optimum ratio and low ratio additive to water concentrations.

During tests, the thermocouples signal wires were terminated at a Connector Box placed approximately 2.5 meters from the back of the test corner assembly. Another set of wires relayed the signals to the Data Acquisition System (DAQ) installed in a secure, waterproof case. The distance from the Connector Box to the DAQ system was approximately 12 meters.

A communications cable connected the DAQ system to a laptop computer where the temperature data was saved for subsequent analysis. The laptop computer required an operator to monitor the DAQ function during all tests.

At the conclusion of tests on an individual test corner assembly, the TC signal wires connectors were disconnected at the Connector Box. The Connector Box was then moved to the next test corner assembly area where the TC signal wires from that unit were connected.

Measurement Parameters:

The following quantitative and qualitative measurements were made during each test.

Temperature—

24 Type ‘K’ thermocouples were placed on the interior surfaces of the test corner assemblies (five on each side wall, three each on the ceiling and floor, and eight on the rear wall). Temperatures were recorded at 1 sample/second via an Automation Direct programmable logic controller system configured for this data acquisition application. Temperature data were stored for subsequent analysis.

Videography (Visible Light)—

Two (2) simple digital video cameras (SJCAM SJ400) were used to collect qualitative imagery of each test. Imagery was collected in a digital format at a minimum of 30 frames per second (fps). The SJCAM cameras used have the capability to record at 60 fps (with reduced pixel resolution). These cameras have a 170-degree wide angle lens and the capability to magnify imagery to up to 4×.

During tests, one camera was placed 8 meters in front of the test corner assembly. The other camera was positioned at an approximately 45° angle and 8 meters to the front of the test corner assemblies. The cameras were mounted on tripods at a height of 1.4 meters.

Videography (Infrared Light)—

One (1) infrared (IR) camera was used to collect qualitative infrared imagery of each test. The IR camera could only produce still imagery in a digital format. A separate laptop computer was used to control the IR camera and record selected images. The IR camera was mounted either on the same tripod for the 45° angle visible light camera or on an adjacent tripod.

Water Flow—

One (1) flow meter (Omega model # FTB8000B) was used to measure the total amount of water being used to extinguish each fire. This meter was a mechanical gauge type meter and readings before and after each test were noted to determine the net amount of water used.

Residual Water—

Prior to conducting a series of tests on each pod, a 3-meter section of eaves trough was attached to the front lip of the test pod. The eaves trough had end pieces attached along with suitable PVC pipe fittings to attach a 2″ diameter flex hose. The flex hose was 15 meters in length. The output from this hose was attached to suitable pipe fittings connected to a rigid pool with a capacity of 380 litres (˜100 US gal.)

At the conclusion of a test, the height of the water in the rigid pool was measured. From this value, the total volume of water in the pool was calculated. The difference in values between what the flow meter indicates and the volume in the rigid pool was the amount of water used to extinguish the conflagration.

Summary of Testing:

The plan of activities entailed a series of individual tests conducted on the 5 test corner assemblies (TCAs).

In the control study, only water was used, with no additive of any kind. Upon initiation of the data acquisition task, the firefighters started a fire in the fire crib located in the TCA. Temperature and video data continued throughout the build-up of flames and heat to the flashover condition; which was identified when the thermocouples on the ceiling of the TCA registered temperatures in the range of from 800-900° C. Upon flashover, the firefighters attacked and completely extinguished the conflagration with water only.

Tests were also performed, in the same manner as described above for the control, using the present concentrate and the two competitor products as additives to water. The ratios of the two competitor products to water were the competitors' suggested optimal ratios. Two ratios of the presently provided concentrate to water were tested (2% and 3% by weight concentrate in the resultant hydrogel).

Results

The temperature data was used to verify that all of the individual trials had similar burning conditions prior to initiation of the fire extinguishments events.

Table 1 shows the results of the trials conducted using water (control), the present concentrate plus water, competitor A additive plus water, and competitor B additive plus water.

TABLE 1

| | Water | Competitor | Competitor | Fire-suppressant | Fire-suppressant |
|---|---|---|---|---|---|
| Fire suppressant | (Control) | A | B | concentrate | concentrate |
| Mix (wt %) | — | | 3 | 2 | 3.5 |
| Total volume of fire | 398 | 314 | 216 | ND | 167 |
| suppressant (litres) | | | | | |
| Duration of test * | 14 | 16 | 13 | 11 | 9 |
| (minutes) | | | | | |
| Event duration ^{†} | 1:15 | 0:48 | 0:59 | 0:27 | 0:35 |
| (minutes:seconds) | | | | | |

* duration of test is the total time from initiation of the fire in the TCA to fire extinguishment;
^{†} the time from start of fire suppressant application to fire extinguishment (“knockdown” time).

Conclusions

The results of the studies summarized above indicate that the hydrogel formed using the herein described concentrate performed better than water alone and better than the two competitor products in terms of water usage. The presently provided hydrogel (when prepared with 3.55 by weight of the concentrate) provided a reduction in water usage in comparison to the use of water alone of approximately 58%, whereas Competitor A provided a reduction in water usage of approximately 21% and Competitor B provided a reduction in water usage of approximately 46%.

These results also demonstrate that the presently provided hydrogel performed better than water alone and better than the two competitor products in terms of fire knockdown time. Even when prepared using only 2% by weight of the concentrate, the knockdown time was significantly improved (i.e., shorter), than when using water alone or when using either of the two competitor products tested.

In addition to the quantifiable aspects of these studies, it was observed that use of the herein described hydrogel provided improved fire suppression and extinguishing effects in that its use allowed the firefighters quicker access into the TCA, with no observed reignition, than with the comparison fire suppressants.

### Example 2: Class B Fire Knockdown

This study was performed to demonstrate the effectiveness of the present fire suppressing hydrogel in extinguishing a class B fire.

Methods and Materials

A fire suppressant hydrogel was prepared as described in Example 1, using water and 4.5% by weight of the concentrate.

A large scale class B fuel fire test, was set up using a square pan (having dimensions of approximately 1 m×1 m) containing at least 5 litres of n-heptane over water. The heptane was ignited and the fire was permitted to build up until the entire pan was engulfed with flame. At this point the fire suppressant hydrogel was sprayed on the fire by the fire fighters.

Results and Conclusions

The total time of the test, from ignition to the time the fire was fully extinguished was 2 minutes. The knockdown time of the heptane (Class B) fire was only 23 seconds, indicating that the hydrogel of the present application is an efficient fire suppressant of class B fires.

### Example 3: Tire Fire Knockdown

An additional study was performed to demonstrate the utility of the present hydrogel in extinguishing a tire fire. Tire fires are well known to be very difficult to extinguish and to produce toxic chemicals from the breakdown of rubber compounds while burning.

In this study a stack of approximately six tires was ignited and permitted to burn until all of the tires were fully involved in the fire, and heavy black smoke was produced from the burning tires)\. The fire suppressant hydrogel, prepared as described above in Example 2, was sprayed on the burning tires by the fire fighters. The hydrogel was effective in quickly knocking down the fire. The knockdown time of the tire fire was 80 seconds.

### Example 4: Stability of Silica-Containing Concentrates

Fire suppression concentrates were prepared using silica as a particulate suspending agent, as set out in the table below:

| | Sample A | Sample B | Sample C |
|---|---|---|---|
| Component | (wt %) | (wt %) | (wt %) |
| Canola oil | 44.35 | 44.35 | 44.35 |
| Xantham gum | 20.6 | 20.6 | 20.6 |
| Guar gum | 14.4 | 14.4 | 14.4 |
| Corn starch | 14.4 | 14.4 | 14.4 |
| Lecithin (Metarin ™ | 4 | 4 | 4 |
| DA 51) | | | |
| Silica (Aerosil ® R 974) | 0.25 | 0.25 | 0.25 |
| Water | 2 | 1 | 2 |

Samples A and B were prepared using the following mixing procedure using a commercial blender:
Added canola oil and MDA51, mixed 30s
Added xantham gum and guar gum to the first mixture, mixed 1 min
Added corn starch to the mixture, mixed 1 min
Added water to the mixture, mixed 1 min
Added silica to the mixture, mixed 1.5 min
Dispensed the resulting mixture into a container and stored at room temperature

Sample C was prepared using a similar procedure, using a 30 RPM drum mixer, which is summarized below:
Added canola oil and MDA51, mixed 5 min
Added xantham gum and guar gum to the first mixture, mixed 10 min
Added corn starch to the mixture, mixed 10 min
Added water to the mixture, mixed 10 min
Added silica to the mixture, mixed 15 min
Dispensed the resulting mixture into a container and stored at room temperature

In each case the samples showed significantly less separation following storage at room temperature than similar samples prepared without silica and stored at room temperature. The addition of water may also improve stability but contributed to an increase in viscosity over time, presumably as the components absorbed more of the water over time.

All of the concentrate formulations prepared in this study were successfully used to prepare a fire suppression hydrogel when mixed with water, or an aqueous solution.

### Example 5: Stability of Phyto-Glycogen Nanoparticle-Containing Concentrates

Fire suppression concentrates were prepared

| | A | B | C | D | E | F | G | H | I | J |
|---|---|---|---|---|---|---|---|---|---|---|
| Component | wt % | wt % | wt % | wt % | wt % | wt % | wt % | wt % | wt % | wt % |
| Canola oil | 43.92 | 44.08 | 44.04 | 43.99 | 44.10 | 44.08 | 40.05 | 42.48 | 43.26 | 43.30 |
| Lecithin | 4.00 | 4.01 | 4.03 | 4.23 | 4.00 | 4.00 | 3.64 | 3.86 | 3.93 | 3.93 |
| (Metarin ™ DA 51) | | | | | | | | | | |
| Xanthan gum | 21.05 | 20.65 | 20.66 | 20.62 | 20.59 | 20.58 | 18.70 | 19.83 | 20.19 | 20.21 |
| Guar gum | 14.26 | 14.28 | 14.28 | 14.29 | 14.40 | 14.39 | 13.07 | 13.87 | 14.12 | 14.13 |
| Corn starch | 14.27 | 14.43 | 0 | 0 | 14.39 | 14.39 | 13.07 | 13.87 | 14.12 | 14.13 |
| Water | 1.99 | 2.01 | 2.00 | 12.65 | 2.02 | 1.92 | 9.17 | 4.87 | 3.51 | 3.22 |
| Phyto-glycogen | 0.50 | 0.55 | 14.98 | 4.22 | 0.50 | 0.64 | 2.30 | 1.23 | 0.88 | 1.08 |
| nanoparticles | | | | | | | | | | |

Formulations A-C were prepared in a blender/mixer according to the following general procedure:
Added canola oil and MDA51 and mixed for 5 min
Added xanthan gum and guar gum and mixed for 10 min
Added corn starch, if present, and mixed for 10 min
Added water and mixed for 10 min
Added the phyto-glycogen and mixed 15 min
Dispensed mixture into a container

Formulations D-J were prepared in a blender/mixer according to the following general procedure:
Added canola oil and MDA51 and mixed for 5 min
Added xanthan gum and guar gum and mixed for 10 min
Added corn starch, if present, and mixed for 10 min
Stirred the phyto-glycogen into the water until dissolved, then added to the mixture and mixed 15 min
Dispensed mixture into a container

The formulations were stored at room temperature and were later tested under accelerated conditions for stability (40° C. oven for 4 days). The samples tested under the accelerated conditions were observed to identify separation or stratification.

Stability was observed to similar to that obtained using silica, with some improvement of stability found when the formulations were prepared using the phyto-glycogen pre-dissolved in the water prior to addition. The addition of phyto-glycogen as a direct replacement for silica resulted in a decrease in the viscosity of the formulation. Viscosity of the formulations was increased with increasing amounts of water.

All of the concentrate formulations prepared in this study were successfully used to prepare a fire suppression hydrogel when mixed with water, or an aqueous solution.

All publications, patents and patent applications mentioned in this Specification are indicative of the level of skill of those skilled in the art to which this invention pertains and are herein incorporated by reference to the same extent as if each individual publication, patent, or patent applications was specifically and individually indicated to be incorporated by reference.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

We claim:

1. A composition comprising:
a. at least one thickening agent;
b. at least one liquid medium; and,
c. at least one particulate suspending agent, wherein the composition consists of >75%, by weight, consumer-grade components and wherein the composition is a concentrate that forms a fire-suppressing hydrogel when mixed with water or an aqueous solution.

2. The composition of claim 1, wherein the composition comprises:
a. 10-75 wt % of at least one thickening agent;
b. 0.1-10 wt % of at least one particulate suspending agent; and
c. 15-90 wt % of at least one liquid medium.

3. The composition of claim 2, wherein the at least one particulate suspending agent is silica or glycogen.

4. The composition of claim 3, wherein the composition comprises one or more additional suspending agent.

5. The composition of claim 4, wherein the composition additionally comprises water at a concentration of less than 5 wt %.

6. The composition of claim 1, which comprises guar gum and xanthan gum as thickening agents.

7. The composition of claim 1, which comprises corn starch, guar gum and xanthan gum as thickening agents.

8. The composition of claim 1, wherein the at least one liquid medium is an edible oil.

9. The composition of claim 8, wherein the edible oil is a vegetable oil.

10. The composition of claim 9, wherein the vegetable oil is canola oil.

11. A hydrogel comprising water and about 0.1% to about 30% by weight of the composition of claim 1.

12. The hydrogel of claim 11, wherein the composition's weight percentage is 0.1-1 wt %, 1-5 wt %, 5-10 wt %, 15-30 wt %.

13. The hydrogel of claim 12, wherein the composition's weight percentage is 1-5 wt %.

14. The hydrogel of claim 11, wherein the hydrogel's viscosity is 0.1-1 CP, 1-5 cP, 5-10 cP, 10-15 CP, 15-30 cP, 30-60 cP, 60-90 cP, 90-120 cP, 120-150 cP, or >150 cP when measured with a Viscolite 700 viscometer.

15. The hydrogel of claim 11, wherein the hydrogel adheres to surfaces to which it is applied.

16. The hydrogel of claim 11, wherein the composition comprises:
a. 10-75 wt % of at least one thickening agent;
b. 0.1-10 wt % of at least one particulate suspending agent; and
c. 15-90 wt % of at least one liquid medium.

17. The hydrogel of claim 11, wherein the at least one particulate suspending agent is silica or glycogen.

18. The hydrogel of claim 17, wherein the composition comprises one or more additional suspending agent.

19. The hydrogel of claim 11, which comprises guar gum and xanthan gum as thickening agents or corn starch, guar gum and xanthan gum as thickening agents.

20. The hydrogel of claim 11, wherein the at least one liquid medium is an edible oil.
